(19) United States
(12) Patent Application Publication
(10) Pub. No.: US 2026/0162582 A1
(43) Pub. Date: Jun. 11, 2026

(54) DISPLAY DATA DRIVER

(71) Applicant: KOREA UNIVERSITY RESEARCH AND BUSINESS FOUNDATION, Seoul (KR)

(72) Inventors: Hyung Min LEE, Seoul (KR); Jae Woong AHN, Gimpo-si (KR); Seung Hun CHOI, Gunpo-si (KR); Jun Yeol AN, Incheon (KR)

(21) Appl. No.: 19/342,087

(22) Filed: Sep. 26, 2025

Related U.S. Application Data
(63) Continuation of application No. PCT/KR2024/003906, filed on Mar. 28, 2024.

(30) Foreign Application Priority Data
Mar. 30, 2023 (KR) 10-2023-0042173

(51) Int. Cl. G09G 3/20

(52) U.S. Cl. CPC G09G 3/2007; G09G 2310/027; G09G 2310/0291; G09G 2310/0294; G09G 2310/0297; G09G 2320/0223; G09G 2320/0276; G09G 2320/0673

(57) ABSTRACT

A display data driver is disclosed. The display data driver comprises: a stepped waveform generator configured to generate a plurality of stepped waveforms, each stepped waveform being composed of N steps; a digital-to-analog converter configured to extract one of the plurality of stepped waveforms; N sample-and-hold circuit units configured to respectively select one step among the steps of the selected stepped waveform; a multiplexer configured to extract one voltage from nonlinear gamma voltages partitioned into N parts in accordance with n most significant bits; and N output amplifiers configured to output respective sums of the outputs of the N sample-and-hold circuit units and the voltage extracted by the multiplexer.

### CROSS-REFERENCE TO RELATED APPLICATION

This application is a continuation of pending PCT International Application No. PCT/KR2024/003906, filed on Mar. 28, 2024, which claims priority to Korean Patent Application No. 10-2023-0042173 filed on Mar. 30, 2023, the entire contents of which are hereby incorporated by references in its entirety.

### TECHNICAL FIELD

The present disclosure relates to a display data driver.

### BACKGROUND ART

In the case of the data driver, area is an important consideration, and when the area of the data driver increases, the overall size of the display driver IC increases and, by virtue of being located at the periphery of the screen, this results in an increase in the size of the bezel.

To address this, interpolation schemes such as those illustrated in FIG. 1 have been proposed. Such interpolation schemes have the advantage of effectively reducing the number of transistors used in the digital-to-analog converter (DAC), thereby reducing the overall size. However, due to the characteristics of a fully nonlinear gamma curve, when an interpolation scheme is used, the effective bits are reduced by about 2 bits, with the drawback that effective driving cannot be achieved. In addition, in some interpolation schemes, an additional amplifier is used, which has the drawback of significantly increased power consumption.

In addition, the power consumption of the data driver is also a matter to be considered. Most of the power consumption in the data driver is determined by the static current used in the buffer. In driving a display panel, the 1-H period for driving one pixel is obtained as 1/(the number of rows×the frame frequency) seconds. This period exponentially decreases as the display resolution increases, which reduces the settling time, requires the output value to converge more quickly, and necessitates an increase in current consumption. To address this, research is also being conducted to achieve low-power operation by adjusting the current consumption.

The structure of a conventional data driver is as illustrated in FIG. 2, and the sample-and-hold circuit system of the display driver is as illustrated in FIG. 3. In general, the sample-and-hold circuit system is composed of a single switch, a sampling capacitor, and an output amplifier. According to the operation of the switch, within the 1-H period, the output V_{gamma} of the digital-to-analog converter (DAC) is stored in the capacitor during the sampling signal, and during the hold signal it is delivered to the display panel through the output amplifier, this is repeated every cycle to drive the panel. In order to drive a high-resolution display, a low parasitic capacitor is required for high frequency and reduced RC time delay. However, in the conventional sample-and-hold circuit, not only is the capacitance of a large sampling capacitor reflected as is, so that the total capacitance increases, making it difficult to implement a small RC time delay. Accordingly, there is a need for a measure to reduce the total capacitance reflected in the sample-and-hold circuit to reduce the RC time delay.

### DISCLOSURE

### Technical Problem

The present disclosure is to provide a display data driver.

In addition, the present disclosure is to provide a display data driver capable of implementing nonlinear gamma curve characteristics by configuring a sample-and-hold circuit that uses a stepped-waveform-based low-voltage band with only a single stage.

In addition, the present disclosure is to provide a display data driver that does not use a level shifter and a method of driving the same.

### Technical Solution

According to one aspect of the present disclosure, a display data driver that does not use a level shifter is provided.

According to an embodiment of the present disclosure, a display data driver may be provided, the display data driver comprising: a stepped waveform generator configured to generate a plurality of stepped waveforms, each stepped waveform being composed of N steps; a digital-to-analog converter configured to select one of the plurality of stepped waveforms; N sample-and-hold circuit units configured to respectively select one step among the steps of the selected stepped waveform; a multiplexer configured to extract one voltage from nonlinear gamma voltages partitioned into N parts in accordance with n most significant bits; and N output amplifiers configured to output respective sums of the outputs of the N sample-and-hold circuit units and the voltage extracted by the multiplexer.

The N sample-and-hold circuit units may include: a sampling capacitor configured to store an output of the digital-to-analog converter; a first source follower circuit disposed on an input side of the sampling capacitor to prevent RC delay of the sampling capacitor, wherein the output of the digital-to-analog converter is delivered to the sampling capacitor through the first source follower circuit; a second source follower circuit configured to compensate for a voltage difference between a gate and a source terminal of a transistor included in the first source follower circuit; a sampling switch configured to switch a connection between the sampling capacitor and the first source follower circuit; a first compensation switch configured to switch a connection between the second source follower circuit and a second input terminal of a corresponding one of the output amplifiers; a second compensation switch configured to switch a connection between an output of the multiplexer and the second input terminal of the corresponding one of the output amplifiers; a first negative-feedback switch configured to switch a negative-feedback loop between an output terminal of the corresponding one of the output amplifiers and a first terminal of the sampling capacitor; and a second negative-feedback switch configured to switch a negative-feedback loop between the output terminal of the corresponding one of the output amplifiers and a second terminal of the sampling capacitor.

The first compensation switch and the second compensation switch are in a toggle relationship, and the first negative-feedback switch and the second negative-feedback switch are in a toggle relationship.

The sample-and-hold circuit unit may be operated sequentially in a charging phase, a drive phase, and an add phase in accordance with a sampling clock.

In accordance with the sampling clock, when the sampling switch is turned ON, the stepped waveform extracted by the digital-to-analog converter is stored in the sampling capacitor through the first source follower circuit so that the sampling capacitor is charged; the first compensation switch is turned ON so that a reference voltage is applied to a second input terminal of the output amplifier through the second source follower circuit; and the second negative-feedback switch is turned ON so that a first negative-feedback loop is formed between an output terminal of the output amplifier and a first node between the sampling capacitor and a first input terminal of the output amplifier, whereby a voltage difference between a gate and a source terminal of a transistor included in the first source follower circuit is compensated in the value stored in the sampling capacitor.

When charging of the sampling capacitor is completed, the display data driver may be operated in a drive phase in which the sampling capacitor is floated so as to prevent AC coupling that would otherwise occur due to a change in an input to a second input terminal of a corresponding one of the output amplifiers from an output of the second source follower circuit to an output of the multiplexer.

In the drive phase, in accordance with the sampling clock, the sampling switch and the first compensation switch are turned OFF, and the second compensation switch is turned ON so that an output of the multiplexer is applied to a second input terminal of a corresponding one of the output amplifiers.

In accordance with the sampling clock, the second negative-feedback switch is turned OFF and the first negative-feedback switch is turned ON such that a second negative-feedback loop is established between an output terminal of a corresponding one of the output amplifiers and a second node between the sampling switch and the sampling capacitor.

### Advantageous Effects

By providing a display data driver that uses a low-voltage-band digital-to-analog converter (DAC) according to an embodiment of the present disclosure, a sample-and-hold circuit that uses a stepped-waveform-based low-voltage band can be configured with only a single stage, thereby implementing nonlinear gamma curve characteristics.

In addition, the present disclosure has the advantage of reducing area by not using a level shifter.

### BRIEF DESCRIPTION OF THE DRAWINGS

FIG. 1 is a diagram illustrating a DAC using a conventional interpolation scheme.

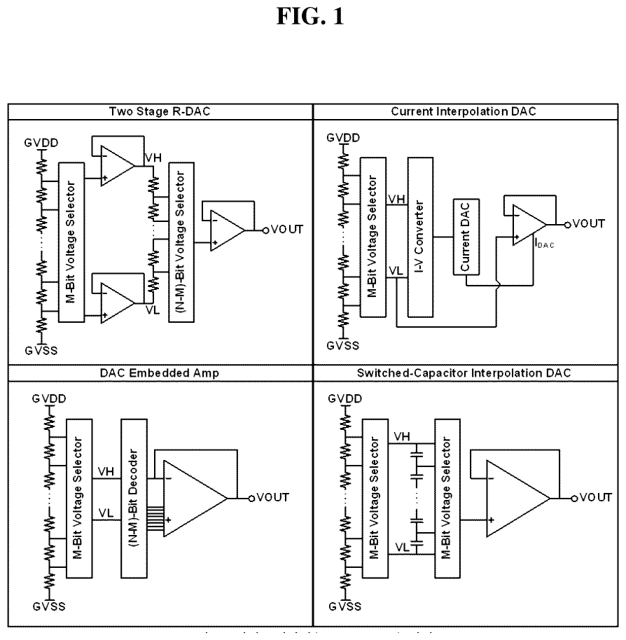

FIG. 2 is a diagram illustrating the structure of a conventional display data driver.

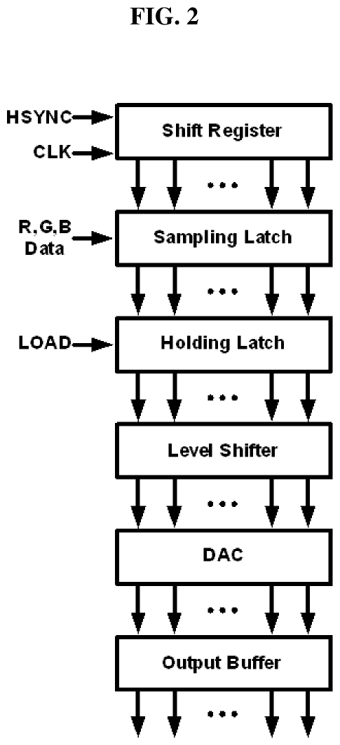

FIG. 3 is a diagram illustrating a conventional sample-and-hold circuit.

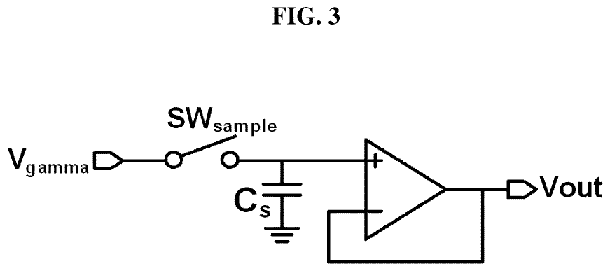

FIG. 4 is a block diagram schematically illustrating the configuration of a display device according to an embodiment of the present disclosure.

FIG. 5 is a diagram schematically illustrating the structure of a display data driver according to an embodiment of the present disclosure.

FIG. 6 is a diagram illustrating a display data driver using a low-voltage-band DAC according to an embodiment of the present disclosure.

FIG. 7 is a circuit diagram of a sample-and-hold circuit unit according to an embodiment of the present disclosure.

FIG. 8 is a diagram illustrating a charging process according to an embodiment of the present disclosure.

FIG. 9 is a diagram illustrating the difference (VSG′-VSG) in the output of a digital-to-analog converter between a long channel and a short channel, according to an embodiment of the present disclosure.

FIG. 10 is a timing diagram according to an embodiment of the present disclosure.

FIG. 11 is a circuit operation diagram of a drive stage according to an embodiment of the present disclosure.

FIG. 12 is a diagram showing simulation results of an output waveform in the absence of a source follower circuit.

FIG. 13 is a circuit operation diagram of an addition stage according to an embodiment of the present disclosure.

FIG. 14 is a diagram showing simulation results of an output waveform of a display data driver according to an embodiment of the present disclosure.

FIG. 15 is a diagram illustrating a stepped waveform in the absence of a source follower circuit.

FIG. 16 is a diagram illustrating a stepped waveform in the presence of a source follower circuit, according to an embodiment of the present disclosure.

FIG. 17 is a diagram showing simulation results of an error waveform in the absence of a drive stage.

FIG. 18 is a diagram showing a comparison of the areas of low-voltage-band and high-voltage-band transistors.

FIG. 19 is a diagram showing a layout result of a data driver when a low-voltage-band digital-to-analog converter is used, according to an embodiment of the present disclosure.

### BEST MODE

In the present specification, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “ . . . unit”, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

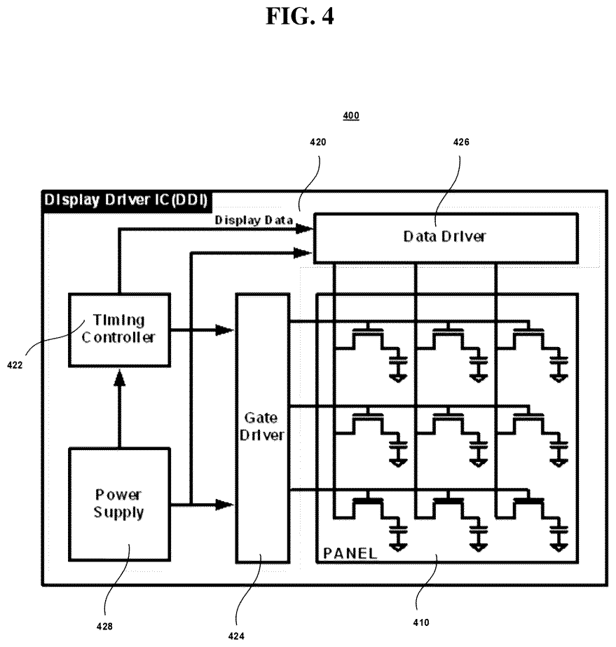

FIG. 4 is a block diagram schematically illustrating the configuration of a display device according to an embodiment of the present disclosure.

Referring to FIG. 4, the display device (400) includes a display panel (410) and a display driving circuit unit (420).

The display driving circuit unit (420) includes a timing controller (422), a gate driver (424), a data driver (426) and a power supply unit (428).

The timing controller (422) may receive image data and input control signal from an external device. For example, the input image data received the external device may include R, G, B data. Depending on the implementation method, the input image data may further include white image data, and may include magenta, yellow, and cyan image data. Meanwhile, the input control signal from the external device may include a master clock signal, a data enable signal, a vertical synchronization signal, a horizontal synchronization signal, and the like.

The timing controller (422) may generate, on the basis of the input control signals, a signal for controlling operation the data driver (426) and output it to the data driver (426).

In addition, the timing controller (422) may generate a data signal on the basis of the input image data and output it to the data driver (426).

Like this, the timing controller (422) serves to adjust the signals of the respective components of the display driving circuit unit (420).

The gate driver (424) may generate gate signals for driving the gate lines in accordance with the control signals of the timing controller (422). The gate driver (424) may output the generated gate signals to the gate lines. The gate driver (424) may sequentially output the gate signals to the gate lines, thereby turning each pixel on and off.

The data driver (426) receives the control signal and the data signal from the timing controller (422) and receive a gamma reference voltage from a gamma reference voltage generator (not shown). The data driver (426) converts the data signal in digital form into a data voltage in analog form by using the gamma reference voltage. The data driver (426) may output the data voltage to the data lines.

The power supply unit (428) is a mean for supplying power.

Hereinafter, the data driver (426) will be described in more detail.

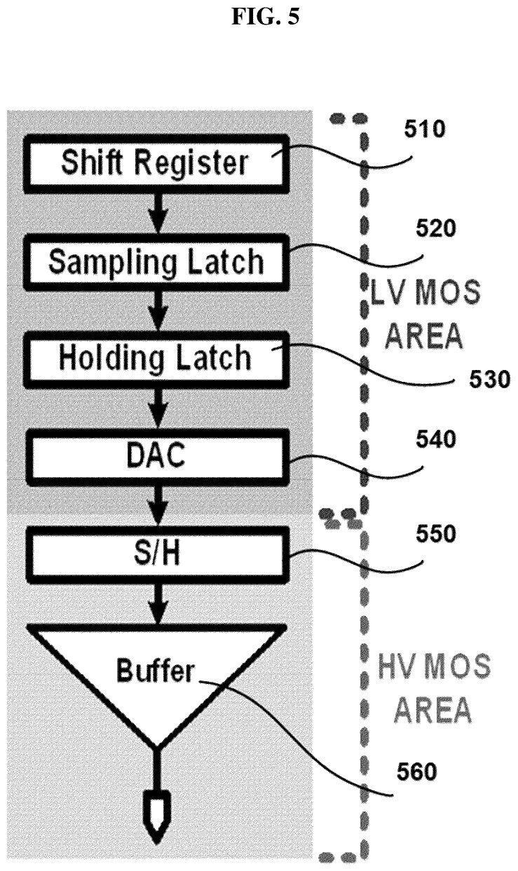

FIG. 5 is a diagram schematically illustrating the structure of a display data driver according to an embodiment of the present disclosure.

Referring to FIG. 5, the data driver (426) according to an embodiment of the present disclosure includes a shift register (510), a sampling latch (520), a holding latch (530), a digital-to-analog converter (540), a sample-and-hold circuit unit (550), and an output amplifier (560).

The shift register (510) may sequentially shift the data signals.

The sampling latch (520) and the holding latch (530) may temporarily store the data signals.

The digital-to-analog converter (540) may convert the data signals in digital form into a data voltage in analog form on the basis of a stepped waveform.

The sample and hold circuit unit (550) is a means for selecting each step of the stepped waveform extracted from the digital-to-analog converter (540) in accordance with a sampling pulse. This will be described in more detail below.

The output amplifier (560) is a means for amplifying the input voltage to the output amplifier (560) and outputting the amplified voltage to the corresponding data line of the display panel (410). According to an embodiment of the present disclosure, the circuitry from the shift register (510) through the digital-to-analog converter (540) is implemented using low-voltage-band transistors. As such, the digital-to-analog converter (540), which was made using high-voltage-band transistors, can be made smaller by using low-voltage-band transistors, and there is an advantage in that, unlike the conventional art, a level shifter can be removed.

The shift register (510), the sampling latch (520) and the holding latch (530) of the display data driver (426) are the same as in the conventional case. Hereinafter, description will focus on the operation of the digital-to-analog converter (540), the sample-and-hold circuit unit (550) and the output amplifier (560), which differ from the conventional case.

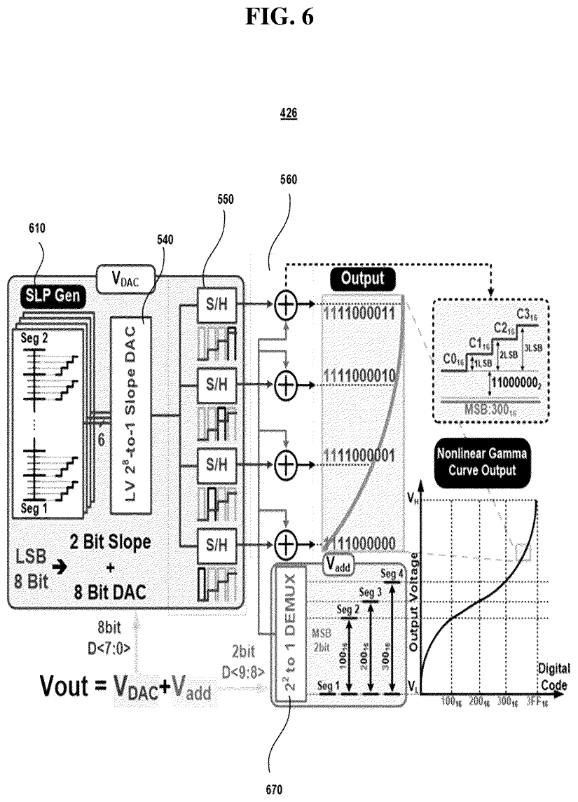

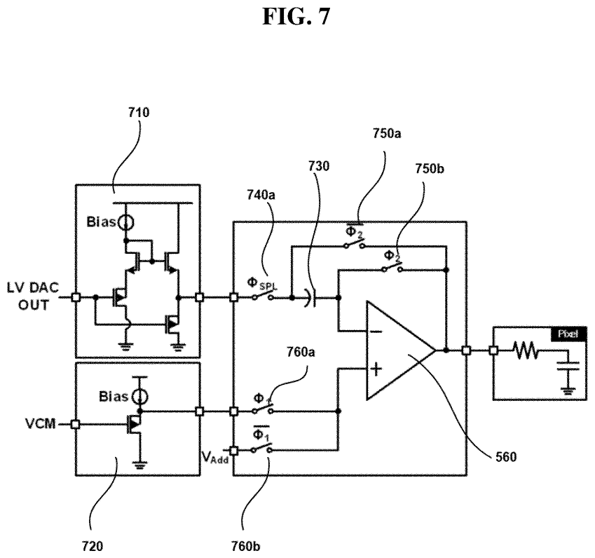

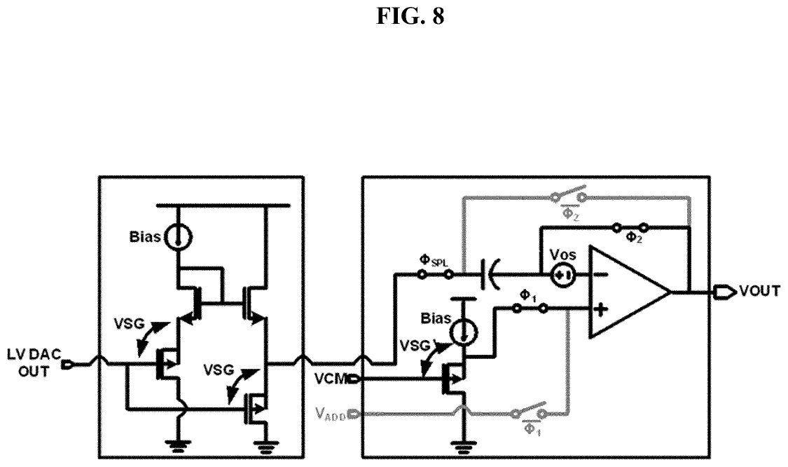

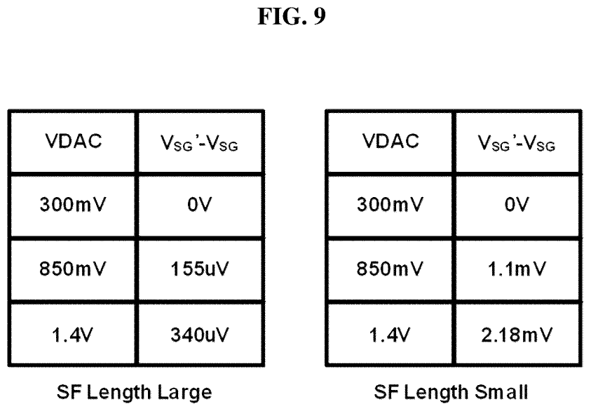

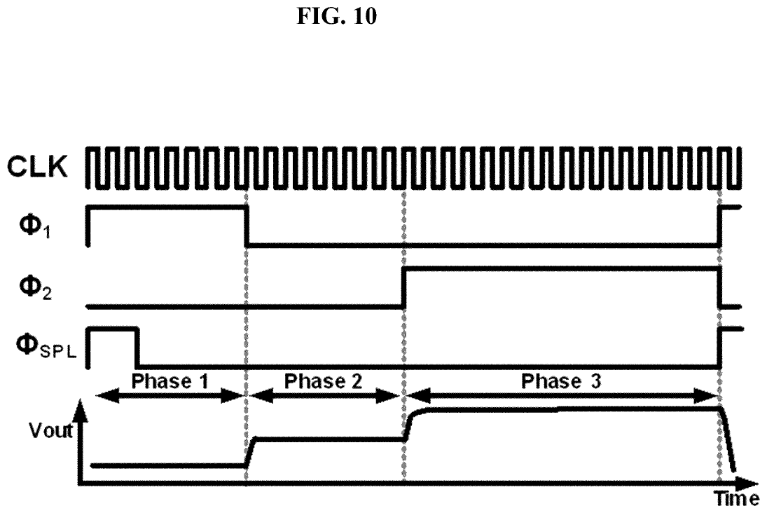

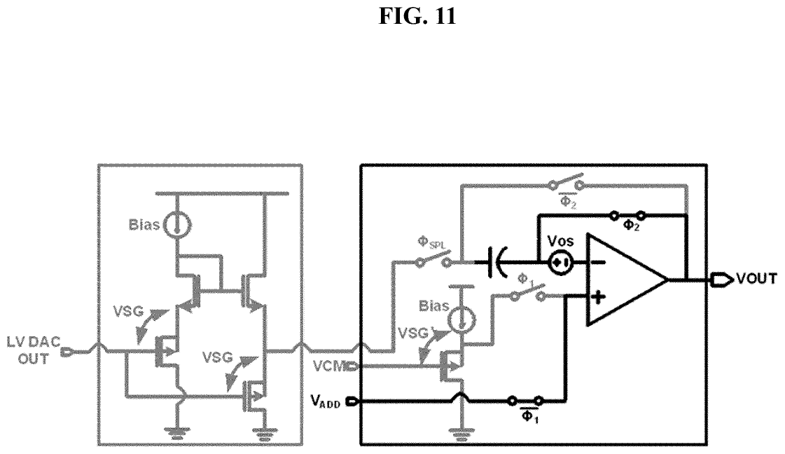

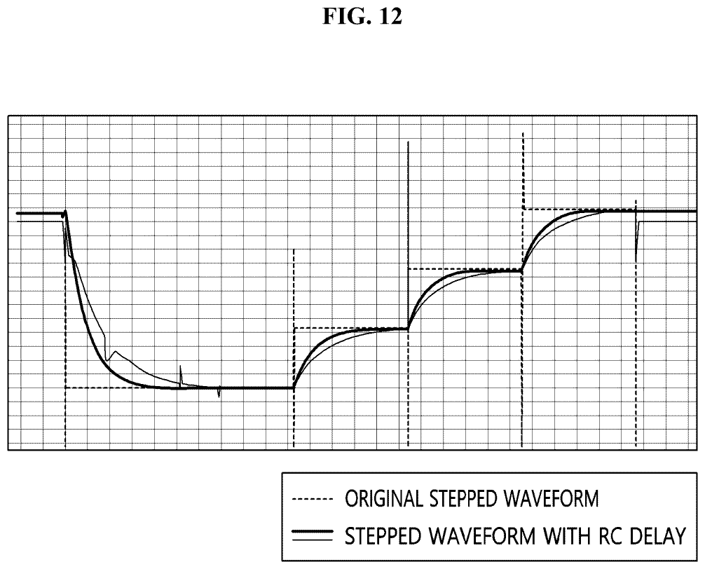

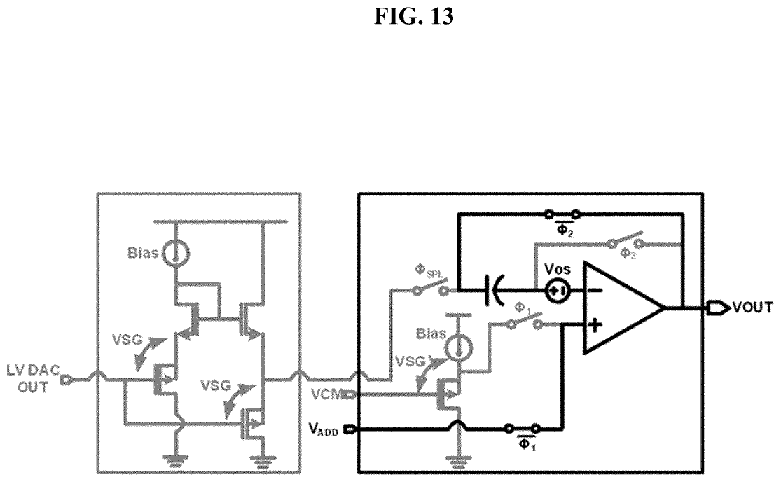

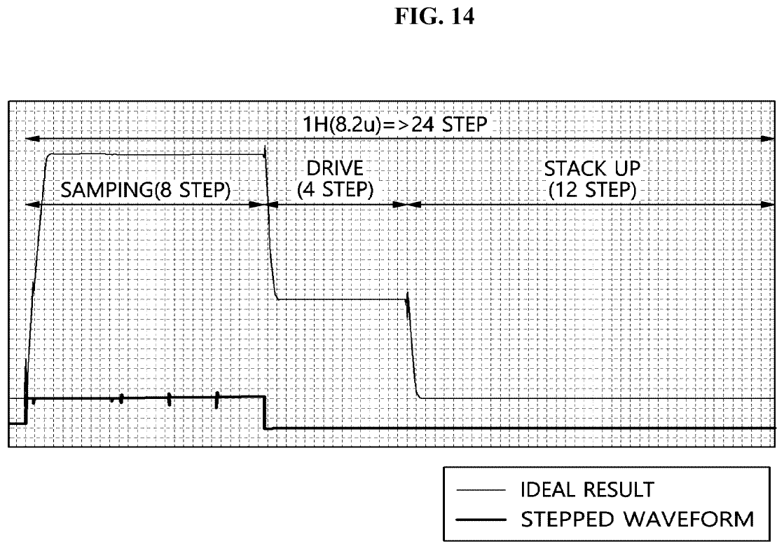

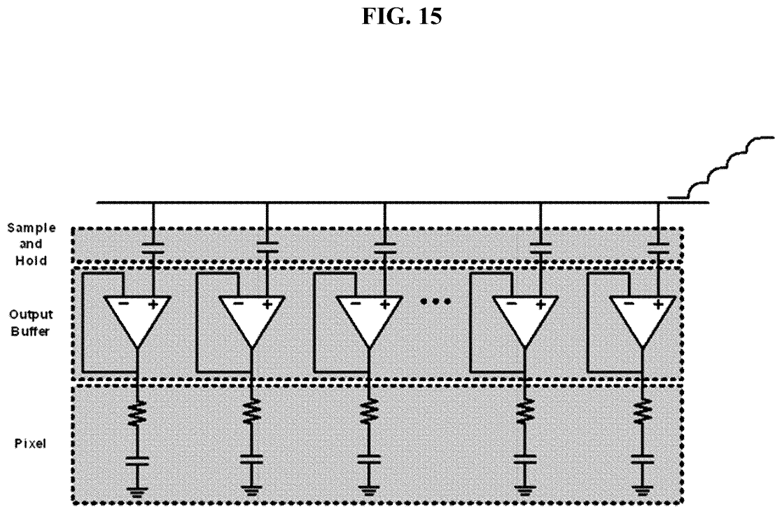

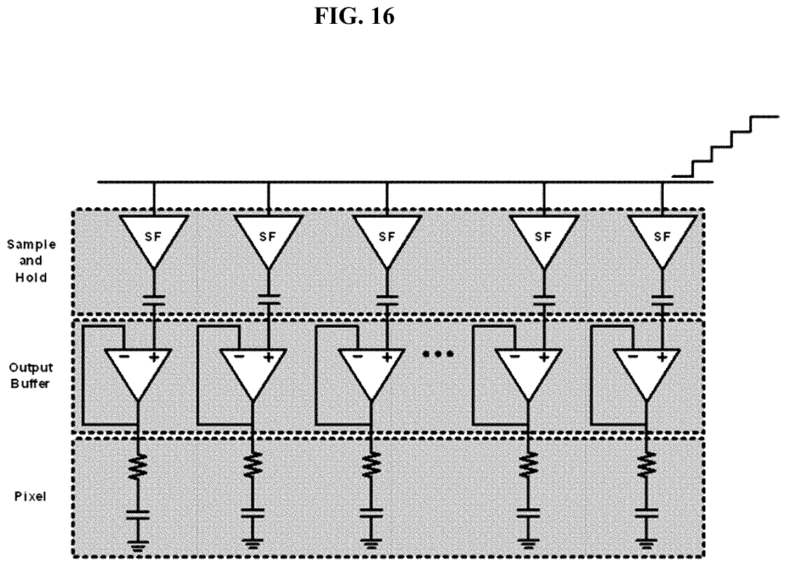

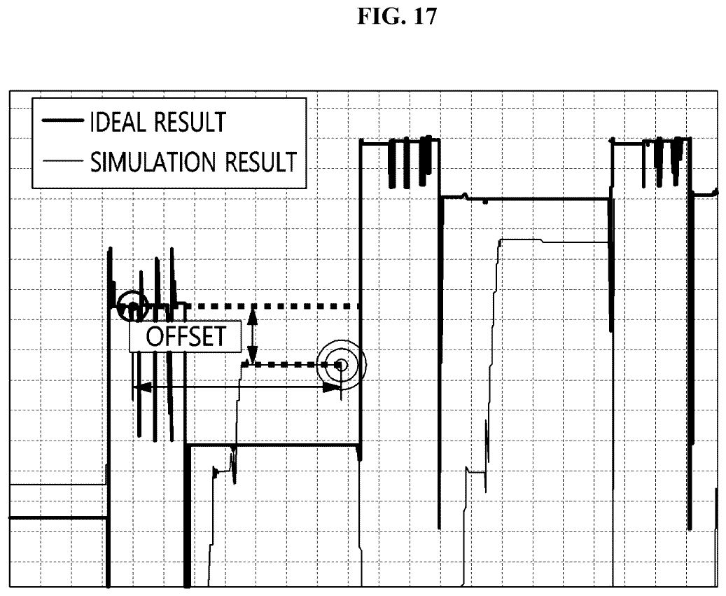

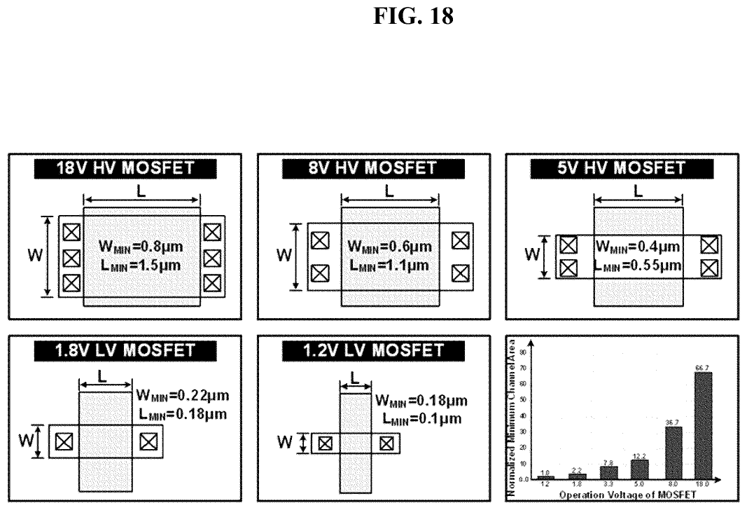

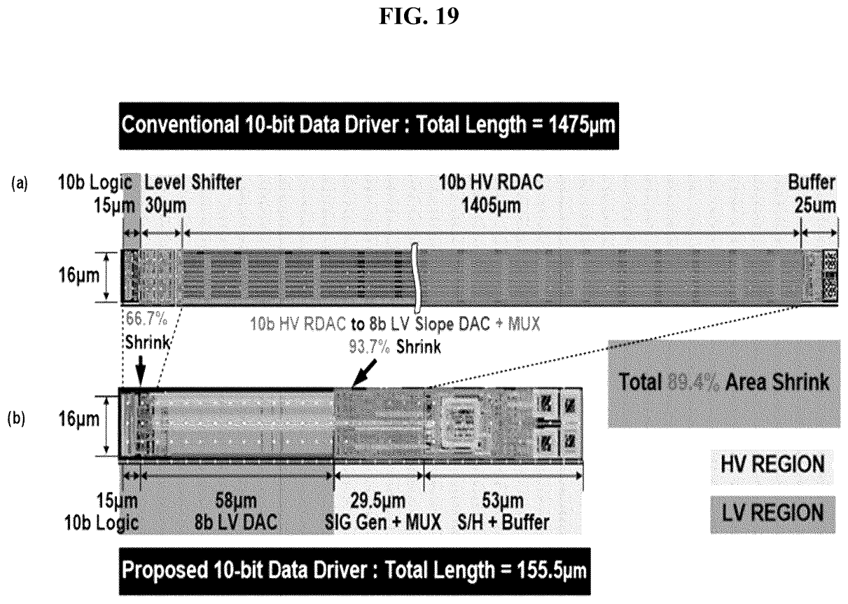

FIG. 6 is a diagram illustrating a display data driver using a low-voltage-band DAC according to an embodiment of the present disclosure, FIG. 7 is a circuit diagram of a sample-and-hold circuit unit according to an embodiment of the present disclosure, FIG. 8 is a diagram illustrating a charging process according to an embodiment of the present disclosure, FIG. 9 is a diagram illustrating the difference (VSG′-VSG) in the output of a digital-to-analog converter between a long channel and a short channel, according to an embodiment of the present disclosure, FIG. 10 is a timing diagram according to an embodiment of the present disclosure, FIG. 11 is a circuit operation diagram of a drive stage according to an embodiment of the present disclosure, FIG. 12 is a diagram showing simulation results of an output waveform in the absence of a source follower circuit, FIG. 13 is a circuit operation diagram of an addition stage according to an embodiment of the present disclosure, FIG. 14 is a diagram showing simulation results of an output waveform of a display data driver according to an embodiment of the present disclosure, FIG. 15 is a diagram illustrating a stepped waveform in the absence of a source follower circuit, FIG. 16 is a diagram illustrating a stepped waveform in the presence of a source follower circuit, according to an embodiment of the present disclosure, FIG. 17 is a diagram showing simulation results of an error waveform in the absence of a drive stage, FIG. 18 is a diagram showing a comparison of the areas of low-voltage-band and high-voltage-band transistors, and FIG. 19 is a diagram showing a layout result of a data driver when a low-voltage-band digital-to-analog converter is used, according to an embodiment of the present disclosure.

Referring to FIG. 6, the display data driver (426) according to an embodiment of the present disclosure includes a stepped waveform generator (610), a digital-to-analog converter (540), a sample-and-hold circuit unit (550), an output amplifier (560) and a multiplexer (670).

The stepped waveform generator (610) is a means for generating a stepped waveform.

For example, in one embodiment of the present disclosure, a 10-bit data driver is assumed. It is assumed that the nonlinear gamma section is divided into four sections, as shown in FIG. 6. In FIG. 6, for ease of understanding and description, it is assumed that the nonlinear gamma voltage is divided into four sections, however, it is not necessarily limited to four sections. The four sections of the nonlinear gamma voltage will be referred to as seg1, seg2, seg3, and seg4, respectively.

Herein, each section of nonlinear gamma voltage corresponds to two most significant bits, and a partial gamma voltage of one of the sections may be extracted by the multiplexer (670). In a data driver having resolution of 10 bits, when each stepped waveform is configured with four steps (2 bits), the digital-to-analog converter (540) may be configured with 8 bits. That is, since the nonlinear gamma voltage section is divided into four sections and each stepped waveform is composed of four steps, each section may have 64 stepped waveforms.

That is, the stepped waveform generator (610) may generate 64 stepped waveforms for each section. Accordingly, since there are 64 stepped waveforms per section, the total number of seppted waveforms may be 256.

The digital-to-analog converter (540) is an (M-N)-bit low-voltage band digital-to-analog converter and, on the basis of the sample-and-hold circuit unit (550) that uses a stepped-waveform-based low-voltage band, can implement nonlinear gamma-curve characteristics with only a single stage.

The digital-to-analog converter (540) is a means for selecting one of the stepped waveforms generated by the stepped waveform generator (610).

When one of the plurality stepped waveforms is selected by the digital-to-analog converter (540), the sample-and-hold circuit unit (550) selects one of the four steps. This is, since each stepped waveform is composed of the four steps, for example, in each of the four sample-and-hold circuit unit (550), a respective step of the stepped waveform extracted in accordance with a sampling pulse may be selected.

According to an embodiment of the present disclosure, as illustrated in FIG. 7, the sample-and-hold circuit unit (550) includes a first source follower circuit unit (710), a second source follower circuit unit (720), a sampling capacitor (730), a sampling switch (740a), a first negative-feedback switch (750a), a second negative-feedback switch (750b), a first compensation switch (760a), and a second compensation switch (760b).

The first source follower circuit unit (710) delivers the output (stepped waveform) of the digital-to-analog converter (540) to the sampling capacitor (730). That is, the output of the digital-to-analog converter (540) may be stored in the sampling capacitor (730) through the first source follower circuit (710) and then output to the display panel (410) through the output amplifier (560).

The second source follower circuit (720) is a means for compensating for the voltage difference (V_{SG}) between the gate and source terminals of the transistor included in the first source follower circuit (710). Accordingly, the second source follower circuit (720) may apply a value (V_{CM}) within the low-voltage band to a second input terminal (e.g., the non-inverting (+) terminal) of the output amplifier (560).

Although the second source follower circuit (720) has the same bias voltage as the first source follower circuit (710), because the input value applied thereto is different, the voltage difference between the gate and source terminals of its transistor (V_{SG′}) becomes different from the voltage difference (Vₑ) between the gate and source terminals of the transistor in the first source follower circuit (710).

The sampling capacitor (730) stores the output (stepped waveform) of the digital-to-analog converter (540) through the first source follower circuit (710).

The charging process (Charging phase) of storing, in the sampling capacitor (730), the output (extracted stepped waveform) of the digital-to-analog converter (540) will be described in more detail with reference to FIG. 8. The timing diagram is as illustrated in FIG. 10.

Through the digital-to-analog converter (540), one of the stepped waveforms generated by the stepped waveform generator (610) is extracted and stored in the sampling capacitor (730) through the first source follower circuit (710). Here, it is assumed that the sampling switch (740a) is in an ON state according to a control signal of the timing controller. At this time, as described above, the output of the digital-to-analog converter (540) is stored at a level increased by the voltage difference (V_{SG}) between the gate and source terminals of the transistor included in the first source follower circuit (710).

Accordingly, the output of the sampling capacitor (730) becomes the output value of the digital-to-analog converter (540) plus V_{SG}, whereby an error relative to the target value occurs.

Accordingly, through the second source follower circuit (720), a value (V_{CM}) within the low-voltage band is applied to the second input terminal (the (+) terminal) of the output amplifier (560). However, as described above, although the second source follower circuit (720) has the same bias as the first source follower circuit (710), since the input value is different, the difference (V_{SG′}) between the gate and source terminals of its transistor is different from that of the first source follower circuit (710).

Accordingly, the second negative-feedback switch (φ₂) is turned ON to activate a negative-feedback loop between the sampling capacitor (730) and the first input terminal (e.g., the inverting (−) terminal) of the output amplifier (560).

As a result, due to the negative-feedback path (Negative feedback) loop, the first input terminal of the output amplifier (560) has V_{CM}+V_{SG′} applied thereto, and the value stored in the sampling capacitor (730) becomes V_{CM}+V_{SG′}+V_{OS}−(V_{DAC}+V_{SG})=(V_{CM}−V_{DAC})+V_{OS}+ (V_{SG′}−V_{SG}). Here, V_{OS} is an offset voltage generated in the output amplifier (560).

In addition, an error of (V_{CM}−V_{SG′}) occurs, which arises from channel-length modulation and the body (substrate) effect. Accordingly, to address this, the body and the source of the transistor in the first source follower circuit (710) are tied together to minimize the body effect, and the channel length is made as long as possible so that, by using a long channel, the effect of channel-length modulation that would otherwise arise with a short channel is minimized. FIG. 9 is a table showing the difference (V_{SG′}−V_{SG}) with respect to V_{DAC} between a long channel and a short channel. Here, because V_{CM} of 300 mV was used, it can be seen that there is no difference at V_{DAC}=300 mV. As V_{DAC} increases, (V_{SG′}−V_{SG}) increases, and it can be confirmed that the magnitude of the difference becomes smaller as a longer channel is used.

When charging of the sampling capacitor (730) is completed, the sample-and-hold circuit unit (550) floats the sampling capacitor (730). For convenience, in one embodiment of the present disclosure, this process will be referred to as drive phase. A circuit operation diagram in the drive phase is as illustrated in FIG. 11. The drive phase will be described with reference to FIG. 11.

In the drive phase, in accordance with a control signal of the timing controller (422), the sampling switch (φ_{SPI}) is turned OFF, and the first compensation switch φ₁) that delivers a reference voltage to the second input terminal of the output amplifier (560) is also turned OFF, while the second compensation switch (φ̅₁̅) is turned ON. As a result, the output of the multiplexer (670) is applied to the second input terminal of the output amplifier (560). The first compensation switch (φ₁) and the second compensation switch (φ̅₁̅) may be toggled. That is, when the first compensation switch (φ₁) is turned OFF, the second compensation switch (φ̅₁̅) is turned ON, and when the first compensation switch (φ₁) is turned ON, the second compensation switch (φ̅₁̅) is turned OFF.

In the drive phase, as the first compensation switch (φ₁) is turned OFF and the second compensation switch (φ̅₁̅) is turned ON, if the sampling capacitor (730) and the output amplifier (560) were connected without the drive stage, the change in voltage from V_{CM} delivered by the second source follower circuit (720) to V_{ADD}, which is the output voltage of the multiplexer (670), would be added to the sampling capacitor (730) by AC coupling, thereby causing a large error (see FIG. 17).

Accordingly, by performing the drive phase after the charging phase, AC coupling can be prevented from affecting the sampling capacitor (730).

Thereafter, in accordance with the control signal of the timing controller (422), the display data driver (426) is operated in an add phase. A circuit operation diagram for the addition phase is illustrated in FIG. 13. The add phase will be described in more detail with reference to FIG. 13.

In the add phase, in accordance with a control signal of the timing controller (422), the second negative-feedback switch (φ₂) is turned OFF, the first negative-feedback switch (φ̅₂̅) is turned ON, and the two terminals of the sampling capacitor (730) are connected to the output amplifier (560). With the first negative-feedback switch (φ̅₂̅) turned ON, through the first negative-feedback loop, the first input terminal of the output amplifier (560) is set to a decreased voltage V_{ADD}, and the final output Vout of the output amplifier becomes V_{ADD} plus the value stored in the sampling capacitor (730).

Accordingly, when the final output value is expressed by an equation, the target value

$${V}_{o u t} = {V}_{A D D} + {V}_{OS} + ( {V}_{D A C} + {V}_{S G} ) - ( {V}_{C M} + {V}_{{SG}^{′}} + {V}_{OS} ) = {V}_{A D D} + {V}_{DAC} - {V}_{CM} + ( {V}_{S G} - {V}_{{SG}^{′}} )$$

is output. It can also be seen that the offset voltage VOS generated in the output amplifier (560) is removed in the last stage. The final output waveform is as illustrated in FIG. 14. In the absence of the drive phase, the final output waveform is as illustrated in FIG. 16.

In a typical sample-and-hold circuit, the sampling capacitor is used relatively large in order to reduce charge injection. However, because the capacitance of the sampling capacitor is reflected as is, a large RC value results, and due to the RC time delay (RC delay) the stepped waveform becomes flattened, so that it fails to settle within the reference time, as in the case without a source follower circuit shown in FIG. 15. Simulation results for this are as illustrated in FIG. 17.

In order to prevent this, in an embodiment of the present disclosure, a source follower circuit is disposed on an input side of the sampling capacitor (730). In this case, from the standpoint of the stepped waveform, only the parasitic gate capacitor (Gate Capacitor) of the source follower is seen, so a relatively small capacitance is reflected. Accordingly, the RC delay time is reduced, so that the stepped waveform remains unaffected even after passing through many channels (see FIG. 16). In the case of the sampling capacitor used in a conventional sample-and-hold circuit, in order to minimize charge injection caused by surrounding switches and clock feedthrough, it is common to set the sampling capacitor value to hundreds of fF to several pF, with a capacitance about 500 to 100 times the gate capacitance of the transistor used as the switch.

However, as in an embodiment of the present disclosure, by disposing the source follower circuit on an input side of the sampling capacitor (730), even if the size of the sampling capacitor is increased, only the parasitic gate capacitor generated in the source follower circuit (on the order of hundreds of aF to several fF) is seen from the digital-to-analog converter. Accordingly, there is an advantage in that the RC time delay can be reduced by tens to hundreds of times.

In addition, if the output of the digital-to-analog converter covers the entire band of the gamma voltage, the source follower must use both an N-channel transistor (N-MOSFET) and a P-channel transistor (P-MOSFET). However, in an embodiment of the present disclosure, since only the low-voltage band is received, it is sufficient to use only a P-channel transistor. When both transistors are used, it is not easy to define the respective ranges over which the N-channel transistor and the P-channel transistor are used. In addition, the variation in the gate-to-source voltage difference of the source follower becomes more pronounced.

In an embodiment of the present disclosure, by using a single transistor to control variation in the gate-to-source voltage difference, the channel length is made as long as possible to reduce channel-length modulation, and the body of the transistor is tied to the source so that sufficient area is secured to address the body effect, thereby reducing error.

In summary, the data driver according to an embodiment of the present disclosure, unlike the conventional case, may employ low-voltage-band transistors from the shift register, sampling latch, and holding latch through the digital-to-analog converter (540). Accordingly, not only may the digital-to-analog converter (540) be made smaller by using low-voltage-band transistors, but there is also the advantage that the level shifter used in the conventional art can be eliminated.

FIG. 18 shows a comparison of the areas of low-voltage-band transistors and high-voltage-band transistors. In general, when designing a data driver having a range of 5 V, the digital region is implemented with 1.2 V low-voltage-band transistors, and from the level shifter to the output amplifier, 5 V high-voltage-band transistors are used.

However, when the digital-to-analog converter (540) is implemented using low-voltage-band transistors as in an embodiment of the present disclosure, the area of each transistor is reduced as compared with the case of using conventional high-voltage-band transistors.

In addition, as shown in FIG. 18, the area of a conventional level shifter implemented with transistors is about 5.3 μm², if this is also eliminated, since ten level shifters can be removed, there is an advantage of reducing the area by 53 μm².

FIG. 19 is a diagram showing a layout result of a data driver when a low-voltage-band digital-to-analog converter is used according to an embodiment of the present disclosure.

In a conventional 10-bit data driver, as shown in FIG. 19 (a), since a digital-to-analog converter employing high-voltage transistors is used, ten level shifters are required and reference voltages must be received from a resistor string of 1,024 resistors.

However, as in an embodiment of the present disclosure (FIG. 19 (b)), when the digital-to-analog converter (540) is implemented with low-voltage devices, a level shifter is not required, so the digital region is reduced by 66.7%. In addition, since a 2-bit stepped waveform is used as well, only an 8-bit digital-to-analog converter (540) is required, it is sufficient to receive only 256 stepped waveforms, and, unlike the conventional structure, low-voltage-band transistors of smaller size are used. Accordingly, an area reduction effect of 93.7% can be obtained. In terms of the total area, a total area reduction effect of 89.4% can be obtained.

Hereinabove, the present disclosure has been described with reference to exemplary embodiments thereof. It will be understood by those skilled in the art to which the present disclosure pertains that the present disclosure may be implemented in a modified form without departing from essential characteristics of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

1. A display data driver comprising:
a stepped waveform generator configured to generate a plurality of stepped waveforms, each stepped waveform being composed of N steps;
a digital-to-analog converter configured to select one of the plurality of stepped waveforms;
N sample-and-hold circuit units configured to respectively select one step among the steps of the selected stepped waveform;
a multiplexer configured to extract one voltage from nonlinear gamma voltages partitioned into N parts in accordance with n most significant bits; and
N output amplifiers configured to output respective sums of the outputs of the N sample-and-hold circuit units and the voltage extracted by the multiplexer.

2. The display data driver of the claim 1, wherein the N sample-and-hold circuit units comprise:
a sampling capacitor configured to store an output of the digital-to-analog converter;
a first source follower circuit disposed on an input side of the sampling capacitor to prevent RC delay of the sampling capacitor, wherein the output of the digital-to-analog converter is delivered to the sampling capacitor through the first source follower circuit;
a second source follower circuit configured to compensate for a voltage difference between a gate and a source terminal of a transistor included in the first source follower circuit;
a sampling switch configured to switch a connection between the sampling capacitor and the first source follower circuit;
a first compensation switch configured to switch a connection between the second source follower circuit and a second input terminal of a corresponding one of the output amplifiers;
a second compensation switch configured to switch a connection between an output of the multiplexer and the second input terminal of the corresponding one of the output amplifiers;
a first negative-feedback switch configured to switch a negative-feedback loop between an output terminal of the corresponding one of the output amplifiers and a first terminal of the sampling capacitor; and
a second negative-feedback switch configured to switch a negative-feedback loop between the output terminal of the corresponding one of the output amplifiers and a second terminal of the sampling capacitor.

3. The display data driver of the claim 2,
wherein the first compensation switch and the second compensation switch are in a toggle relationship, and
the first negative-feedback switch and the second negative-feedback switch are in a toggle relationship.

4. The display data driver of the claim 2,
Wherein the sample-and-hold circuit unit is operated sequentially in a charging phase, a drive phase, and an add phase in accordance with a sampling clock.

5. The display data driver of the claim 2,
wherein, when the sampling switch is turned ON in accordance with a sampling clock, the stepped waveform extracted by the digital-to-analog converter is stored in the sampling capacitor through the first source follower circuit so that the sampling capacitor is charged,
the first compensation switch is turned ON so that a reference voltage is applied to a second input terminal of a corresponding one of the output amplifiers through the second source follower circuit, and
the second negative-feedback switch is turned ON so that a first negative-feedback loop is established between an output terminal of the corresponding one of the output amplifiers and a first node between the sampling capacitor and a first input terminal of the output amplifier, thereby compensating a voltage difference between a gate and a source terminal of a transistor included in the first source follower circuit in the value stored in the sampling capacitor.

6. The display data driver of the claim 5,
wherein, when charging of the sampling capacitor is completed, it is operated in a drive phase in which the sampling capacitor is floated so as to prevent AC coupling that would otherwise occur due to a change in an input to a second input terminal of a corresponding one of the output amplifiers from an output of the second source follower circuit to an output of the multiplexer.

7. The display data driver of the claim 6,
wherein, in the drive phase, in accordance with the sampling clock, the sampling switch and the first compensation switch are turned OFF, and the second compensation switch is turned ON so that an output of the multiplexer is applied to a second input terminal of a corresponding one of the output amplifiers.

8. The display data driver of the claim 2,
wherein, in accordance with the sampling clock, the second negative-feedback switch is turned OFF and the first negative-feedback switch is turned ON such that a second negative-feedback loop is established between an output terminal of a corresponding one of the output amplifiers and a second node between the sampling switch and the sampling capacitor.
